(19) United States
(12) Patent Application Publication
(10) Pub. No.: US 2015/0358900 A1
(43) Pub. Date: Dec. 10, 2015

(54) Network Selection Method and User Equipment

(71) Applicant: Huawei Device Co., Ltd., Shenzhen (CN)

(72) Inventors: Xiaoyan Duan, Beijing (CN); Guowei Ouyang, Beijing (CN); Chenliang Gao, Shenzhen (CN); Hui Jin, Beijing (CN); Qiang Yi, Beijing (CN)

(21) Appl. No.: 14/827,022

(22) Filed: Aug. 14, 2015

Related U.S. Application Data
(63) Continuation of application No. PCT/CN2014/071902, filed on Feb. 8, 2014.

(30) Foreign Application Priority Data
Feb. 25, 2013 (CN) 201310058220.5

(51) Int. Cl. H04W 48/18; H04W 8/18; H04W 48/16

(52) U.S. Cl. CPC H04W 48/18; H04W 48/16; H04W 8/183; H04W 84/12

(57) ABSTRACT

Embodiments of the present invention provide a network selection method and user equipment. The method includes accessing a first wireless local area network WLAN access device by using a non-3rd Generation Mobile Communication 3GPP subscription; attaching to a 3GPP core network by using a 3GPP access network; determining whether a 3GPP subscription has a higher priority than the non-3GPP subscription; and accessing a WLAN by using the 3GPP subscription if the 3GPP subscription has a higher priority than the non-3GPP subscription.

This application is a continuation of International Application No. PCT/CN2014/071902, filed on Feb. 8, 2014, which claims priority to Chinese Patent Application No. 201310058220.5, filed on Feb. 25, 2013, both of which are incorporated herein by reference in their entireties.

### TECHNICAL FIELD

Embodiments of the present invention relate to communications technologies, and in particular, to a network selection method and user equipment.

### BACKGROUND

To implement control or impact by an operator on user equipment (UE for short) with respect to selection of an access network, for example, a wireless local area network (WLAN for short), and a 3rd Generation Partnership Project (3GPP for short), a 3GPP standard specifies that an access network discovery selection function (ANDSF for short) server is disposed on a core network, so as to provide an access network discovery and selection function policy (ANDSF policy) for the user equipment.

In the prior art, when user equipment accesses a WLAN by using a non-3GPP subscription, and receives a ANDSF policy by using a 3GPP network, the user equipment periodically checks the ANDSF policy, so as to determine whether to reselect a WLAN access network. If the ANDSF policy indicates that another WLAN network is preferentially selected, the user equipment ends a connection to a current WLAN network and accesses a new WLAN network.

However, in some scenarios, the user equipment is not expected to reselect a WLAN network or to change a manner of accessing a WLAN, for example, a case in which a tariff for accessing, by the user equipment, a WLAN network by using a non-3GPP subscription is relatively low, but a tariff for accessing the WLAN by using a 3GPP subscription is relative high. Therefore, a manner of accessing a new WLAN network according to the ANDSF policy may conflict with a current access manner of the user equipment by using the non-3GPP subscription, and the new WLAN network accessed according to the ANDSF policy may conflict with a WLAN network accessed by using the non-3GPP subscription.

### SUMMARY

Embodiments of the present invention provide a network selection method and user equipment, which are used to resolve the following problems in the prior art: a problem that a WLAN network access device reselected according to an ANDSF policy may conflict with a WLAN access device currently accessed by the user equipment by using a non-3GPP subscription, and a problem that a manner, which is of accessing a WLAN network by the user equipment and uses a 3GPP subscription instead of the non-3GPP subscription, may conflict with a manner in which the user equipment is expected to access the WLAN by using the non-3GPP subscription.

According to a first aspect, an embodiment of the present invention provides a network selection method, including: accessing a first wireless local area network WLAN access device by using a non-3rd Generation Mobile Communication 3GPP subscription, and attaching to a 3GPP core network by using a 3GPP access network; determining whether a 3GPP subscription has a higher priority than the non-3GPP subscription; and accessing, if the 3GPP subscription has a higher priority than the non-3GPP subscription, a WLAN by using the 3GPP subscription.

In a first possible implementation manner of the first aspect, before the determining whether a 3GPP subscription has a higher priority than the non-3GPP subscription, the method includes: receiving a first access network discovery and selection function ANDSF policy sent by the 3GPP core network, and selecting a second WLAN access device according to the first ANDSF policy; and the accessing, if the 3GPP subscription has a higher priority than the non-3GPP subscription, a WLAN by using the 3GPP subscription includes: if the 3GPP subscription has a higher priority than the non-3GPP subscription, ending a connection to the first WLAN access device, and accessing the second WLAN access device by using the 3GPP subscription.

With reference to the first possible implementation manner of the first aspect, in a second possible implementation manner, the method further includes: if the 3GPP subscription does not have a higher priority than the non-3GPP subscription, disabling or ignoring the first ANDSF policy.

With reference to the second possible implementation manner of the first aspect, in a third possible implementation manner, after the disabling or ignoring the first ANDSF policy, the method further includes: re-enabling the first ANDSF policy after the connection to the first WLAN access device ends.

In a fourth possible implementation manner of the first aspect, the accessing a first WLAN access device by using a non-3GPP subscription, and attaching to a 3GPP core network by using a 3GPP access network includes: accessing the first WLAN access device by using the non-3GPP subscription, and then attaching to the 3GPP core network by using the 3GPP access network; and the accessing, if the 3GPP subscription has a higher priority than the non-3GPP subscription, a WLAN by using the 3GPP subscription includes: determining whether the first WLAN access device can be accessed by using the 3GPP subscription, and if yes, accessing the first WLAN access device by using the 3GPP subscription.

With reference to the fourth possible implementation manner of the first aspect, in a fifth possible implementation manner, the method further includes: receiving a second ANDSF policy sent by the 3GPP core network, and if the 3GPP subscription does not have a higher priority than the non-3GPP subscription, disabling or ignoring the second ANDSF policy.

With reference to the fifth possible implementation manner of the first aspect, in a sixth possible implementation manner, after the disabling or ignoring the second ANDSF policy, the method further includes: enabling the second ANDSF policy after a connection to the first WLAN access device ends.

With reference to the first aspect or any one of the first possible implementation manner to the sixth possible implementation manner of the first aspect, in a seventh possible implementation manner, the determining whether a 3GPP subscription has a higher priority than the non-3GPP subscription includes: acquiring user preference information about whether to access a WLAN by preferentially using a 3GPP subscription; or acquiring a subscription priority that is in a management object and about whether to access a WLAN by preferentially using a 3GPP subscription; or sending, to a user, prompt information about whether to access a WLAN by preferentially using a 3GPP subscription, and receiving selection information that is input according to the prompt information by the user.

According to a second aspect, an embodiment of the present invention provides user equipment, including: a first connection module, configured to access a first wireless local area network WLAN access device by using a non-3rd Generation Mobile Communication 3GPP subscription; a second connection module, configured to attach to a 3GPP core network by using a 3GPP access network; a determining module, configured to determine whether a 3GPP subscription has a higher priority than the non-3GPP subscription; and a third connection module, configured to: if the 3GPP subscription has a higher priority than the non-3GPP subscription, access a WLAN by using the 3GPP subscription.

In a first possible implementation manner of the second aspect, the user equipment further includes: a first receiving module, configured to receive a first access network discovery and selection function ANDSF policy sent by the 3GPP core network; and a selecting module, configured to select a second WLAN access device according to the first ANDSF policy; and the third connection module is configured to: if the 3GPP subscription has a higher priority than the non-3GPP subscription, end a connection to the first WLAN access device, and access the second WLAN access device by using the 3GPP subscription.

With reference to the first possible implementation manner of the second aspect, in a second possible implementation manner, the user equipment includes: a first disabling module, configured to: if the 3GPP subscription does not have a higher priority than the non-3GPP subscription, disable or ignore the first ANDSF policy.

With reference to the second possible implementation manner of the second aspect, in a third possible implementation manner, the user equipment further includes: a first re-enabling module, configured to: if the first ANDSF policy is disabled or ignored, re-enable the first ANDSF policy after the connection to the first WLAN access device ends.

In a fourth possible implementation manner of the second aspect, the first connection module is further configured to: first access the first WLAN access device by using the non-3GPP subscription; the second connection module is configured to: after the first connection module first accesses the first WLAN access device by using the non-3GPP subscription, then attach to the 3GPP core network by using the 3GPP access network; the determining module is further configured to determine whether the first WLAN access device can be accessed by using the 3GPP subscription; and the third connection module is configured to: if the determining module determines that the first WLAN access device can be accessed by using the 3GPP subscription, access the first WLAN access device by using the 3GPP subscription.

With reference to the fourth possible implementation manner of the second aspect, in a fifth possible implementation manner, the user equipment further includes: a second receiving module, configured to receive a second access network discovery and selection function ANDSF policy sent by the 3GPP core network; and a second disabling module, configured to: if the 3GPP subscription does not have a higher priority than the non-3GPP subscription, disable or ignore the second ANDSF policy.

With reference to the fifth possible implementation manner of the second aspect, in a sixth possible implementation manner, the user equipment further includes: a second re-enabling module, configured to: if the second ANDSF policy is disabled or ignored, enable the second ANDSF policy after a connection to the first WLAN access device ends.

With reference to the second aspect or any one of the first possible implementation manner to the sixth possible implementation manner of the second aspect, in a seventh possible implementation manner, the determining module is specifically configured to: acquire user preference information about whether to access a WLAN by preferentially using a 3GPP subscription; or acquire a subscription priority that is in a management object and about whether to access a WLAN by preferentially using a 3GPP subscription; or send, to a user, prompt information about whether to access a WLAN by preferentially using a 3GPP subscription, and receive selection information that is input according to the prompt information by the user.

According to the network selection method and the user equipment that are provided in the embodiments of the present invention, the user equipment accesses a first WLAN network access device by using a non-3GPP subscription, and attaches to a 3GPP core network by using a 3GPP access network; and when determining that a 3GPP subscription has a higher priority than the non-3GPP subscription in accessing a WLAN network access device, the user equipment accesses a WLAN by using the 3GPP subscription. In this case, the following problems are avoided: a WLAN network access device reselected by the user equipment according to an ANDSF policy may conflict with a WLAN access device currently accessed by the user equipment by using the non-3GPP subscription, and a manner, which is of accessing a WLAN network by the user equipment and uses the 3GPP subscription instead of the non-3GPP subscription, may conflict with a manner in which the user equipment is expected to access the WLAN by using the non-3GPP subscription. In addition, in the embodiments, the user equipment autonomously determines priorities of the 3GPP subscription and the non-3GPP subscription; and only when the user equipment accesses the WLAN in a 3GPP subscription manner after determining that the 3GPP subscription has a higher priority, the user equipment needs to execute the ANDSF policy sent by the 3GPP core network, so that the ANDSF policy does not need to be frequently checked in a periodic manner, thereby avoiding an increase in power consumption of the user equipment caused by unnecessary reselection of a WLAN access device.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is a flowchart of Embodiment 1 of a network selection method according to the present invention;

FIG. 2A is a signaling flowchart of Embodiment 2 of a network selection method according to the present invention;

FIG. 2B is a decision-making flowchart of user equipment in FIG. 2A;

FIG. 3A is a signaling flowchart of Embodiment 3 of a network selection method according to the present invention;

FIG. 3B is a decision-making flowchart of user equipment in FIG. 3A;

FIG. 4 is a schematic architectural diagram of Embodiment 1 of user equipment according to the present invention;

FIG. 5 is a schematic architectural diagram of Embodiment 2 of user equipment according to the present invention;

FIG. 6 is a schematic architectural diagram of Embodiment 3 of user equipment according to the present invention; and

FIG. 7 is a schematic architectural diagram of Embodiment 4 of user equipment according to the present invention.

### DETAILED DESCRIPTION OF ILLUSTRATIVE EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

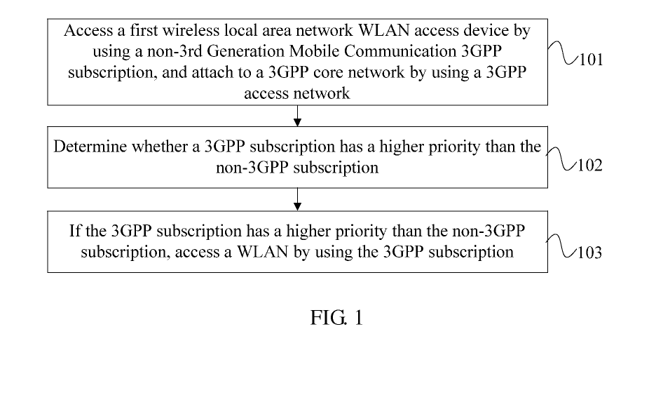

FIG. 1 is a flowchart of Embodiment 1 of a network selection method according to the present invention. This embodiment is applicable to a scenario in which when user equipment accesses a first WLAN access device by using a non-3GPP subscription and attaches to a 3GPP core network by using a 3GPP access network, the user equipment needs to reselect a WLAN access device or change a current manner of accessing the access device. This embodiment is executed by user equipment, and specifically, this embodiment includes the following steps.

Step 101: Access a first wireless local area network WLAN access device by using a non-3rd Generation Mobile Communication 3GPP subscription, and attach to a 3GPP core network by using a 3GPP access network.

The user equipment may access a WLAN network in two manners. In the first manner, the user equipment may access the first WLAN network access device by using the non-3GPP subscription such as a user name plus a password and in an authentication manner provided by a WLAN, where the first access device is, for example, an access point (AP for short) or a hotspot in the WLAN network, and may be identified by using a service set identifier (SSID for short), a basic service set identifier (BSSID for short), a homogenous extended service set ID (HESSID for short), and/or the like. In the second manner, according to an interworking standard that is between a 3GPP network and a WLAN network and specified by standard organizations, such as 3GPP and Wi-Fi (Wireless Fidelity, which refers to a wireless local area network WLAN technology) Alliance, the user equipment may use its subscription to a 3GPP network, that is, the user equipment may base on an international mobile subscriber identity (IMSI for short), another identifier or number, or the like that can uniquely indicate the equipment or a user in the 3GPP network, so as to access a WLAN network access device to perform communication. In this step, the user equipment accesses the first WLAN network access device by using the non-3GPP subscription, and attaches to the 3GPP core network by using the 3GPP access network.

Step 102: Determine whether a 3GPP subscription has a higher priority than the non-3GPP subscription.

According to user preference information; or a subscription priority in a subscription management object; or by sending, to a user, prompt information about whether to access a WLAN by preferentially using a 3GPP subscription, and receiving selection information that is input according to the prompt information by the user; or the like, the user equipment determines a manner that is of accessing a WLAN network and that has a higher priority, that is, determines priorities for accessing, by using the 3GPP subscription and the non-3GPP subscription, a WLAN network access device.

Step 103: If the 3GPP subscription has a higher priority than the non-3GPP subscription, access a WLAN by using the 3GPP subscription.

When determining that the 3GPP subscription has a higher priority than the non-3GPP subscription in accessing the WLAN network, the user equipment accesses the WLAN by using the 3GPP subscription. Specifically, the user equipment determines, according to an ANDSF policy delivered by the 3GPP core network, that a second WLAN network access device needs to be reselected; and when determining that the 3GPP subscription has a higher priority than the non-3GPP subscription in accessing a WLAN network access device, the user equipment accesses the second WLAN access device by using the 3GPP subscription. Alternatively, because the user equipment first accesses the first WLAN access device in a non-3GPP subscription manner, and then attaches to the 3GPP core network, the user equipment accesses the current first access device by using the 3GPP subscription when determining that the 3GPP subscription has a higher priority than the non-3GPP subscription in accessing a WLAN network access device.

According to the network selection method provided in this embodiment of the present invention, user equipment accesses a first WLAN network access device by using a non-3GPP subscription, and attaches to a 3GPP core network by using a 3GPP access network; and when determining that a 3GPP subscription has a higher priority than the non-3GPP subscription in accessing a WLAN network access device, the user equipment accesses the WLAN network access device by using the 3GPP subscription. In this case, the following problems are avoided: a WLAN network access device reselected by the user equipment according to an ANDSF policy may conflict with a WLAN access device currently accessed by the user equipment by using the non-3GPP subscription, and a manner, which is of accessing a WLAN network by the user equipment and uses the 3GPP subscription instead of the non-3GPP subscription, may conflict with a manner in which the user equipment is expected to access the WLAN by using the non-3GPP subscription. In addition, in this embodiment, the user equipment autonomously determines priorities of the 3GPP subscription and the non-3GPP subscription; and only when the user equipment accesses the WLAN in a 3GPP subscription manner after determining that the 3GPP subscription has a higher priority, the user equipment needs to execute the ANDSF policy sent by the 3GPP core network, so that the ANDSF policy does not need to be frequently checked in a periodic manner, thereby avoiding an increase in power consumption of the user equipment caused by unnecessary reselection of a WLAN access device.

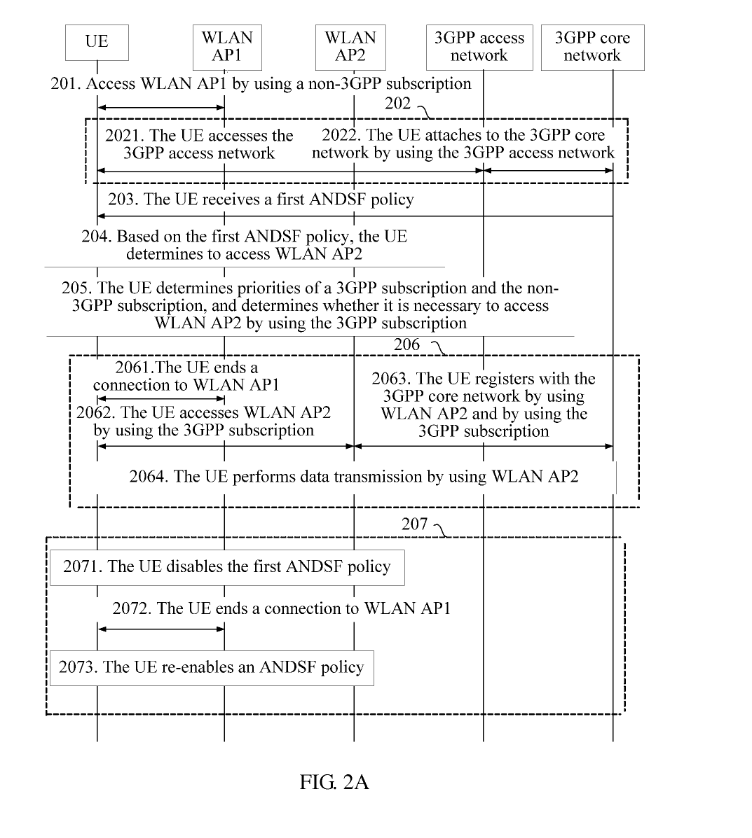

FIG. 2A is a signaling flowchart of Embodiment 2 of a network selection method according to the present invention. This embodiment is applicable to a scenario in which when user equipment receives a first access network discovery and selection function ANDSF policy sent by a 3GPP core network and selects a second WLAN access device according to the first ANDSF policy, and after it is determined that a 3GPP subscription has a higher priority than a non-3GPP subscription, the user equipment needs to reselect a WLAN network access device. In this embodiment, AP1 is a first access device, AP2 is a second access device, and UE accesses AP1 by using a non-3GPP subscription, and attaches to a 3GPP core network by using a 3GPP access network, that is, the user equipment also attaches to the 3GPP core network by using the 3GPP access network when the user equipment accesses WLAN AP1, or before or after the user equipment accesses WLAN AP1. Specifically, this embodiment includes the following steps:

Step 201: The UE accesses WLAN AP1 by using the non-3GPP subscription.

Step 202: The UE attaches to a 3GPP core network by using the 3GPP access network.

Specifically, this step includes the following sub-steps.

Step 2021: The UE accesses the 3GPP access network.

Step 2022: The UE attaches to the 3GPP core network by using the 3GPP access network.

For a specific manner of attaching to the 3GPP network by the UE by using the 3GPP access network, reference may be made to the prior art, and details are not described herein again.

Step 203: The UE receives a first ANDSF policy.

Specifically, a 3GPP network device is disposed in the 3GPP core network, such as an ANDSF server, where the ANDSF server stores network information of a preferred WLAN network so as to provide a WLAN network discovery and selection policy for the UE. In this step, the UE receives the first ANDSF policy sent by the ANDSF server of the 3GPP core network.

Step 204: Based on the first ANDSF policy, the UE determines to access WLAN AP2.

Specifically, in a position A and/or during a time period B, WLAN AP2 has a higher priority than WLAN AP1 in the first ANDSF policy, and therefore, the UE determines to access WLAN AP2.

Step 205: The UE determines priorities of a 3GPP subscription and the non-3GPP subscription, and determines whether it is necessary to access WLAN AP2 by using the 3GPP subscription; if necessary, performs step 206; if unnecessary, performs step 207.

The UE determines the priorities of the 3GPP subscription and the non-3GPP subscription so as to determine whether it is necessary to access WLAN AP2 by using the 3GPP subscription, that is, access a new WLAN network access device by using the 3GPP subscription. Specifically, the UE may acquire access preference information that is preset by a user and about whether to access a WLAN by preferentially using a 3GPP subscription; or send, to a user, prompt information about whether to access a WLAN by preferentially using a 3GPP subscription, for example, the UE prompts, in a manner of popping up a dialog box, the user to select whether to access WLAN AP2 by preferentially using the 3GPP subscription, and then receives selection information that is input according to the prompt information by the user, so as to determine whether it is necessary to select a WLAN network access device by using the 3GPP subscription.

In addition, for user equipment that supports Hotspot2.0, the UE may also determine, according to a subscription priority in a configured device management object (MO for short), whether it is necessary to select a WLAN network access device by using a 3GPP subscription. Specifically, in this embodiment, if it is determined according to the first ANDSF policy that AP2 has a higher priority than AP1, and the UE queries the subscription priority in the MO. When WLAN network AP2 that is accessed by using the 3GPP subscription has a higher priority than WLAN network AP1 that is accessed by using the non-3GPP subscription, the UE accesses WLAN AP2 by using the 3GPP subscription; otherwise, if the 3GPP subscription does not have a higher priority than the non-3GPP subscription, the UE accesses WLAN AP1 by continuing to use the non-3GPP subscription. In this case, because a manner of accessing a WLAN by user equipment and an accessed WLAN network access device are selected according to a Hotspot2.0 policy, that is, according to a WLAN access network selection policy provided by an operator, a problem that the Hotspot2.0 policy conflicts with an ANDSF policy can be resolved.

Step 206: The UE determines that it is necessary to access WLAN AP2 by using the 3GPP subscription.

In the first ANDSF policy, if WLAN AP2 has a higher priority than WLAN AP1, and the UE determines that the 3GPP subscription has a higher priority than the non-3GPP subscription, the UE accesses WLAN AP2 by using the 3GPP subscription, that is, performs step 2061 to step 2064.

Step 2061: The UE ends a connection to WLAN AP1.

The UE ends the connection, which is established based on the non-3GPP subscription, to WLAN AP1.

Step 2062: The UE accesses WLAN AP2 by using the 3GPP subscription.

Step 2063: The UE registers with the 3GPP core network by using WLAN AP2 and by using the 3GPP subscription.

In step 2062 and step 2063, that the UE accesses WLAN AP2 by using the 3GPP subscription includes that: the UE is connected to the 3GPP core network by using WLAN AP2 so that the UE completes authentication and registration on the 3GPP core network. Specifically, the 3GPP subscription includes an identifier generated based on an IMSI, for example, a network access identifier (NAI for short) or another identifier or number that can uniquely indicate the equipment or a user in the 3GPP network. The IMSI includes mobile country code (MCC for short), mobile network code (MNC for short), and a mobile subscriber identification number (MSIN for short). A manner of performing authentication and registration on the 3GPP network by using WLAN AP2 and by using the 3GPP subscription includes: an Extensible Authentication Protocol-subscriber identity module (EAP-SIM for short) manner, an Extensible Authentication Protocol-Authentication and Key Agreement (EAP-AKA for short) manner, EAP-AKA′ manner, and the like.

Step 2064: The UE performs data transmission by using WLAN AP2.

Specifically, the UE may transmit, based on an inter-system routing policy (ISRP for short) in the first ANDSF policy, different Internet Protocol (IP for short) data streams by using WLAN AP2 and the 3GPP access network. That is, the UE selects, according to the ISRP, the 3GPP access network and WLAN AP2 to transmit different IP data streams. For example, the UE separately transmits, by using the 3GPP access network and WLAN AP2, IP data streams that belong to different access point names (APN for short) or belong to different applications.

Step 207: The UE determines that it is necessary to access WLAN AP1 by continuing to use the non-3GPP subscription.

Specifically, if determining that the 3GPP subscription does not have a higher priority than the non-3GPP subscription, the UE does not need to access WLAN AP2 by using the 3GPP subscription, but accesses WLAN AP1 by continuing to use the non-3GPP subscription, and performs step 2071 to step 2073.

Step 2071: The UE disables the first ANDSF policy.

Specifically, the UE does not execute a received ANDSF policy about WLAN access device discovery and selection, no longer periodically assesses the first ANDSF policy about WLAN access device discovery and selection according to the prior art, and does not access a new WLAN access device according to the first ANDSF policy, so as to avoid unnecessary reselection of a WLAN access device and an unnecessary change of an access manner.

Step 2072: The UE ends a connection to WLAN AP1.

Specifically, when the UE moves out of a coverage area of WLAN AP1, or when a signal of WLAN AP1 attenuates to a specific extent, or when the UE cannot perform a communications service by using WLAN AP1 due to another reason, the UE ends the connection, which is established based on the non-3GPP subscription, to WLAN AP1.

Step 2073: The UE re-enables an ANDSF policy.

Because the UE attaches to the 3GPP core network by using the 3GPP access network after the UE ends the connection, which is established based on the non-3GPP subscription, to WLAN AP1, the UE may re-enable the ANDSF policy about WLAN access device discovery and selection, so as to perform WLAN access network discovery and selection. Specifically, that the UE re-enables the ANDSF policy about WLAN access device discovery and selection may further include that: the UE receives the ANDSF policy from the 3GPP core network again, so as to update the ANDSF policy, in the UE, about WLAN access device discovery and selection.

It should be noted that, step 201 may also be performed after step 202, which is not limited in the present invention.

According to the network selection method provided in this embodiment of the present invention, when user equipment accesses a first WLAN network access device by using a non-3GPP subscription and attaches to a 3GPP core network by using a 3GPP access network, and when the user equipment needs to reselect a WLAN access device after receiving a first ANDSF policy delivered by the 3GPP core network, the user equipment may determine whether a 3GPP subscription has a higher priority than the non-3GPP subscription, that is, determine priorities of manners of accessing a WLAN network, and the user equipment determines, according to the priorities, whether to reselect a WLAN network access device, thereby avoiding a problem that a WLAN network access device determined according to an ANDSF policy conflicts with a WLAN network access device that a user currently uses and that is not expected to change. In addition, if the user equipment is user equipment that supports Hotspot2.0, whether the 3GPP subscription has a higher priority than the non-3GPP subscription is determined according to a subscription priority of a configured MO, so that a problem that a Hotspot2.0 policy conflicts with the ANDSF policy can be avoided.

FIG. 2B is a decision-making flowchart of user equipment in FIG. 2A, and FIG. 2B is a further description for a decision-making process of the user equipment in FIG. 2A. This embodiment of the present invention is described in detail according to how the UE makes a decision. Specifically, referring to FIG. 2B, this embodiment may include the following steps:

Step 301: UE attaches to a 3GPP core network by using a 3GPP access network.

Step 302: The UE selects, based on a first ANDSF policy, whether to access WLAN AP2 by using a 3GPP subscription; if the UE selects to access WLAN AP2 by using the 3GPP subscription, perform step 303; otherwise, the method ends.

Step 303: Determine whether the UE already accesses WLAN AP1 by using a non-3GPP subscription; if the UE accesses WLAN AP1 by using the non-3GPP subscription, perform step 305; otherwise, if the user equipment already accesses WLAN AP1 by using the 3GPP subscription, perform step 304.

Specifically, the UE may determine, in any one of the following manners, whether the UE currently accesses WLAN AP1 and accesses WLAN AP1 by using the non-3GPP subscription. A variable may be set in the UE, for example, an access network subscription indication (subscription_ind_for_WL), which is used to indicate whether the UE currently accesses a WLAN by using the non-3GPP subscription. When the UE successfully accesses the WLAN network by using the non-3GPP subscription (for example, in a manner of user name+password), an indication value is set to 0, that is, subscription_ind_for_WL=0; when the UE successfully accesses the WLAN network by using the 3GPP subscription (for example, an EA-SIM, EAP-AKA, or EAP-AKA′ manner), the indication value is set to 1, that is, subscription_ind_for_WL=1; when the UE is not connected to any WLAN network, the indication value is set to 2, that is, subscription_ind_for_WL=2. For the UE, subscription_ind_for_WL=2 may be set as a default value or an initial value. In this way, the UE may determine, based on the access network subscription indication, whether the UE currently accesses a WLAN network access device and accesses the WLAN network access device by using the non-3GPP subscription.

The UE may further directly determine, according to a WLAN access status of the UE and in an authentication manner, whether the UE currently accesses a WLAN network access device by using the non-3GPP subscription. Specifically, if the WLAN access status of the UE is an accessed (associated) state or a data transmission state, and an authentication manner that is based on an IMSI or another 3GPP identifier is not used, the UE currently accesses a WLAN network and accesses the WLAN network by using the non-3GPP subscription.

Step 304: If already accessing WLAN AP1 by using the 3GPP subscription, the UE ends a connection to WLAN AP1, and accesses WLAN AP2 by using the 3GPP subscription.

Step 305: The UE determines whether the 3GPP subscription has a higher priority than the non-3GPP subscription.

Step 306: The UE determines, according to a result obtained by comparing priorities of the 3GPP subscription and the non-3GPP subscription, whether to access WLAN AP2 by using the 3GPP subscription; if the 3GPP subscription has a higher priority than the non-3GPP subscription, the UE determines to access WLAN AP2 by using the 3GPP subscription, and performs step 308; otherwise, if it is unnecessary to access WLAN AP2 by using the 3GPP subscription, performs step 307.

Step 307: The UE disables the first ANDSF policy until a connection, which is established based on the non-3GPP subscription, to WLAN AP1 ends.

Step 308: The UE ends the connection to WLAN AP1, and accesses WLAN AP2 by using the 3GPP subscription.

In this embodiment, the present invention is described in detail according to how UE makes a decision. Specifically, the user equipment attaches to a 3GPP core network by using a 3GPP access network, and the user equipment may autonomously determine whether to access a WLAN network access device by using a non-3GPP subscription. When the user equipment needs to reselect a WLAN access device after receiving a first ANDSF policy delivered by the 3GPP core network, the user equipment may first determine whether a 3GPP subscription has a higher priority than the non-3GPP subscription, that is, determine priorities of manners of accessing a WLAN network access device; and determine, according to the priorities, whether to reselect a WLAN network access device, thereby avoiding a problem that a WLAN network access device provided by an ANDSF policy conflicts with a WLAN network access device that a user currently uses and that is not expected to change.

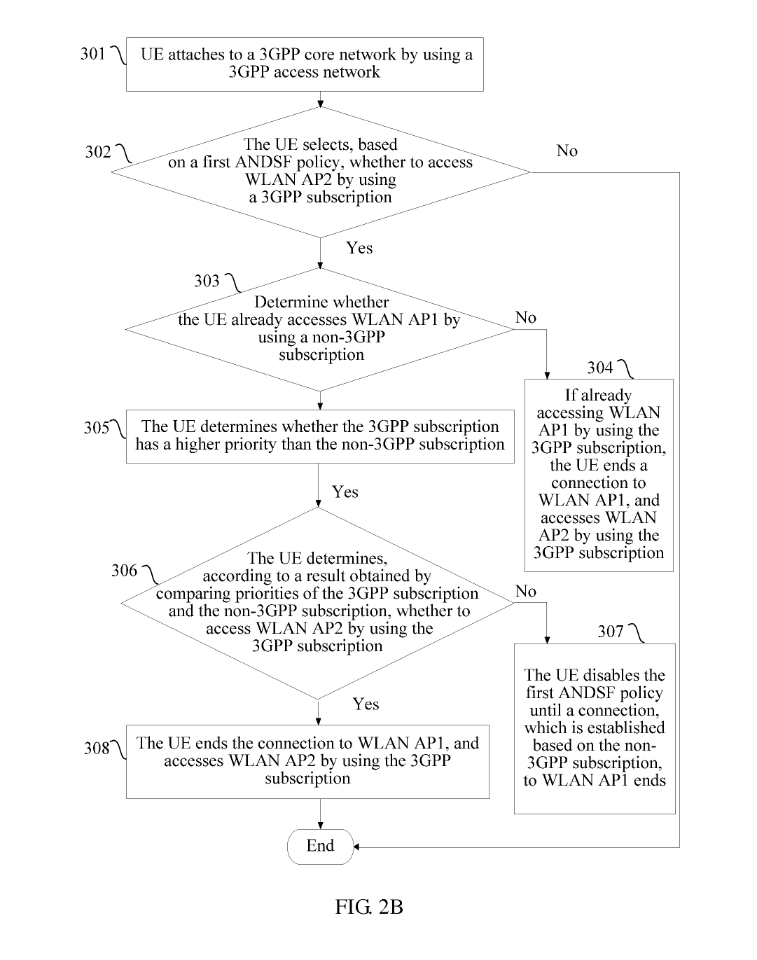

FIG. 3A is a signaling flowchart of Embodiment 3 of a network selection method according to the present invention. This embodiment is applicable to a scenario in which user equipment determines whether a 3GPP subscription has a higher priority than a non-3GPP subscription, that is, determines priorities of manners of accessing a WLAN network access device; and determines, according to the priorities, whether to change a current manner of accessing the WLAN network access device. In this embodiment, AP1 is a first access device, and after accessing AP1 by using a non-3GPP subscription, UE attaches to a 3GPP core network by using a 3GPP access network. Specifically, this embodiment includes the following steps.

Step 401: The UE accesses WLAN AP1 by using the non-3GPP subscription.

Step 402: The UE attaches to the 3GPP core network by using the 3GPP access network.

Specifically, this step includes the following sub-steps.

Step 4021: The UE accesses the 3GPP access network.

Step 4022: The UE attaches to the 3GPP core network by using the 3GPP access network.

For a specific manner of attaching to the 3GPP network by the UE by using the 3GPP access network, reference may be made to the prior art, and details are not described herein again.

Step 404: The UE determines priorities of a 3GPP subscription and the non-3GPP subscription so as to determine whether it is necessary to access WLAN AP1 by using the 3GPP subscription; if it is necessary to access WLAN AP1 by using the 3GPP subscription, performs step 405; otherwise, if it is unnecessary to access WLAN AP1 by using the 3GPP subscription, accesses, by continuing to use the current non-3GPP subscription, WLAN AP1 to perform communication, that is, performs step 406.

Because the UE first accesses WLAN AP1 by using the non-3GPP subscription, and then attaches to the 3GPP core network by using the 3GPP access network; in this case, the UE is triggered to change a manner of accessing WLAN AP1. In this embodiment, the UE first determines the priorities of the 3GPP subscription and the non-3GPP subscription, that is, determines priorities of manners of accessing a WLAN network access device; and then determines whether to access WLAN AP1 by using the 3GPP subscription, that is, change a current manner of accessing the WLAN network access device. Similar to step 205 shown in FIG. 2A, in this step, the UE may also determine, whether it is necessary to access WLAN AP1 by using the 3GPP subscription, in the following manners: acquiring access preference information that is preset by a user and about whether to access a WLAN network access device by preferentially using a 3GPP subscription; or sending, to a user, prompt information about whether to access a WLAN access device by preferentially using a 3GPP subscription, and receiving selection information of the user; or when the user equipment is user equipment that supports Hotspot2.0, querying a subscription priority of an MO so as to determine whether it is necessary to access WLAN AP1 by using the 3GPP subscription.

Step 405: The UE determines that it is necessary to access WLAN AP1 by using the 3GPP subscription.

Specifically, if determining that the 3GPP subscription has a higher priority than the non-3GPP subscription, and determining that it is necessary to access WLAN AP1 by using the 3GPP subscription, the UE performs step 4051 to step 4054.

Step 4051: The UE ends a connection to WLAN AP1.

The UE ends the connection, which is established based on the non-3GPP subscription, to WLAN AP1.

Step 4052: The UE accesses WLAN AP1 by using the 3GPP subscription.

Step 4053: The UE registers with the 3GPP core network by using WLAN AP1 and by using the 3GPP subscription.

Step 4054: The UE performs data transmission by using WLAN AP1.

Specifically, for a process of performing step 4051 to step 4054, reference may be made to a process of performing step 2061 to step 2064 in FIG. 2A, and details are not described herein again.

Step 406: The UE determines to access WLAN AP1 by continuing to use the non-3GPP subscription.

In addition, optionally, in this embodiment, after attaching to the 3GPP network by using the 3GPP access network, the UE may further receive a second ANDSF policy sent by an ANDSF server of the 3GPP network, that is, step 403 is further included, that is step 403 with a dashed arrow in the figure.

Step 403: The UE receives a second ANDSF policy.

In the foregoing steps, whether the UE needs to change a current manner of accessing a WLAN network is triggered because the UE first accesses WLAN AP1 by using the non-3GPP subscription, and then attaches to the 3GPP core network by using the 3GPP access network, Therefore, this step is optional, and in a practical scenario, this step may be selectively performed as required. If this step is performed during the foregoing process, the user equipment may further determine, according to the received second ANDSF policy, whether it is necessary to select a new WLAN network access device. Specifically, reference may be made to FIG. 2A and FIG. 2B, and details are not described herein again.

Optionally, if step 403 is performed in this embodiment, that is, the UE receives the second ANDSF policy sent by a network device of the 3GPP core network, when the UE determines that it is unnecessary to access WLAN AP1 by using the 3GPP subscription, that is, when a current manner of accessing a WLAN network does not change, step 406 specifically includes the following substeps.

Step 4061: The UE disables the second ANDSF policy.

Specifically, the UE does not execute the received second ANDSF policy about WLAN access device discovery and selection, no longer periodically assesses the second ANDSF policy about WLAN access device discovery and selection according to the prior art, and does not access a new WLAN access device according to the second ANDSF policy, so as to avoid unnecessary reselection of a WLAN access device and an unnecessary change of an access manner.

Step 4062: The UE ends a connection to WLAN AP1.

Specifically, when the UE moves out of a coverage area of WLAN AP1, or when a signal of WLAN AP1 attenuates to a specific extent, or when the UE cannot perform a communications service by using WLAN AP1 due to another reason, the UE ends the connection, which is established based on the non-3GPP subscription, to WLAN AP1.

Step 4063: The UE re-enables an ANDSF policy.

Specifically, the UE may re-enable the ANDSF policy about WLAN access device discovery and selection after the UE ends the connection, which is established based on the non-3GPP subscription, to WLAN AP1, so as to perform WLAN access device discovery and selection. Specifically, that the UE re-enables the ANDSF policy about WLAN access device discovery and selection may further include that: the UE receives the ANDSF policy from the 3GPP core network again, so as to update the ANDSF policy, in the UE, about WLAN access device discovery and selection.

According to the network selection method provided in this embodiment of the present invention, after first accessing WLAN AP1 by using a non-3GPP subscription, and then attaching to a 3GPP core network by using a 3GPP access network, user equipment may determine whether a 3GPP subscription has a higher priority than the non-3GPP subscription, that is, determine priorities of manners of accessing a WLAN network access device; and determine, according to the priorities, whether it is necessary to change a current manner of accessing the WLAN access device, thereby avoiding a problem that the user equipment is forced to access a current WLAN network by using the 3GPP subscription.

FIG. 3B is a decision-making flowchart of user equipment in FIG. 3A, and FIG. 3B is a further description for a decision-making process of the user equipment in FIG. 2A. This embodiment of the present invention is described in detail according to how the UE makes a decision. Specifically, referring to FIG. 3B, this embodiment may include the following steps:

Step 501: UE attaches to a 3GPP core network by using a 3GPP access network.

Step 502: Determine whether the UE already accesses WLAN AP1 by using a non-3GPP subscription; if the UE accesses WLAN AP1 by using the non-3GPP subscription, perform step 503; otherwise, if the user equipment already accesses WLAN AP1 by using a 3GPP subscription or the UE is not connected to any WLAN network access device, the method ends.

Step 503: Determine whether the UE can access WLAN AP1 by using the 3GPP subscription; if the UE can access WLAN AP1 by using the 3GPP subscription, perform step 504; otherwise, if the UE cannot access WLAN AP1 by using the 3GPP subscription, the method ends.

The UE may determine, in any one of the following manners, whether a WLAN network currently accessed by the UE can be accessed by using the 3GPP subscription. For example, the UE may establish and maintain a table of a WLAN access network and a subscription corresponding to the WLAN access network, where the table includes a WLAN network having a subscription, and subscription information that is in this network and can be used by the UE, such as an authentication manner and a key. Table 1 is a comparison table of a WLAN access device and a subscription of the WLAN access device that are provided in this embodiment.

TABLE 1

| WLAN network access devices | Subscriptions/Credentials |
|---|---|
| WLAN AP1/SSID1 | 3GPP subscription 1 |
| | Non-3GPP subscription 1 |
| WLAN AP2/SSID2 | Non-3GPP subscription 2 |
| WLAN AP3/SSID3 | 3GPP subscription 3 |

With reference to Table 1, for example, a WLAN network access device may be WLAN AP1 indicated by SSID1, WLAN AP2 indicated by SSID2, or WLAN AP3 indicated SSID3. WLAN AP1 has two types of subscriptions, and the user equipment may access WLAN AP1 by using the 3GPP subscription, that is, 3GPP subscription 1, or the user equipment may access WLAN AP1 by using the non-3GPP subscription, that is, non-3GPP subscription 1. Likewise, the user equipment may access WLAN AP2 by using non-3GPP subscription 2, and the user equipment may access WLAN AP3 by using 3GPP subscription 3. In this step, the user equipment determines, by using the established and maintained comparison table of a WLAN access device and a subscription of the WLAN access device, whether the currently accessed WLAN can be accessed by using the 3GPP subscription.

In addition, a subscription management object (Subscription MO) may be configured inside the user equipment, for example, a subscription management object specified by a Hotspot2.0 standard, where the subscription management object includes subscription information of a WLAN network that can be accessed by the UE, so that the user equipment can determine, by querying the subscription management object, whether the user equipment can access WLAN AP1 by using the 3GPP subscription.

The user equipment may further query, by using the Access Network Query Protocol (ANQP for short) specified in the Institute of Electrical and Electronics Engineers (IEEE for short) 802.11u, information about a 3GPP network, such as 3GPP cellular network information and a network access identifier realm list (NAI Realm List), that interworks with a WLAN network access device, such as WLAN AP1. If the information, obtained by the user equipment by means of query, about the interworking 3GPP network includes information matching the 3GPP subscription (for example, an IMSI) of the user equipment, for example, a public land mobile network (PLMN for short) or an NAI that matches the IMSI of the user equipment, it indicates that the user equipment can access the current WLAN network by using the 3GPP subscription.

Step 504: The UE determines whether the 3GPP subscription has a higher priority than the non-3GPP subscription.

Step 505: The UE determines, according to a result obtained by comparing priorities of the 3GPP subscription and the non-3GPP subscription, whether to access WLAN AP1 by using the 3GPP subscription; if the UE determines to access WLAN AP1 by using the 3GPP subscription, performs step 507; otherwise, if it is unnecessary to access WLAN AP1 by using the 3GPP subscription, performs step 506.

Step 506: The UE disables an ANDSF policy until a connection, which is established based on the non-3GPP subscription, to WLAN AP1 ends.

Step 507: The UE ends the connection, which is established based on the non-3GPP subscription, to WLAN AP1, and accesses WLAN AP1 by using the 3GPP subscription.

It should be noted that, step 504 may also be performed before step 503, which is not limited in the present invention.

In this embodiment, the present invention is described in detail according to how UE makes a decision. Specifically, after first accessing WLAN AP1 by using a non-3GPP subscription, and then attaching to a 3GPP core network by using a 3GPP access network, the user equipment may determine whether a 3GPP subscription has a higher priority than the non-3GPP subscription, that is, determine priorities of manners of accessing a WLAN network access device; and determine, according to the priorities, whether it is necessary to change a current manner of accessing a WLAN network access device, thereby avoiding a problem that the user equipment is forced to access the current WLAN network access device by using the 3GPP subscription.

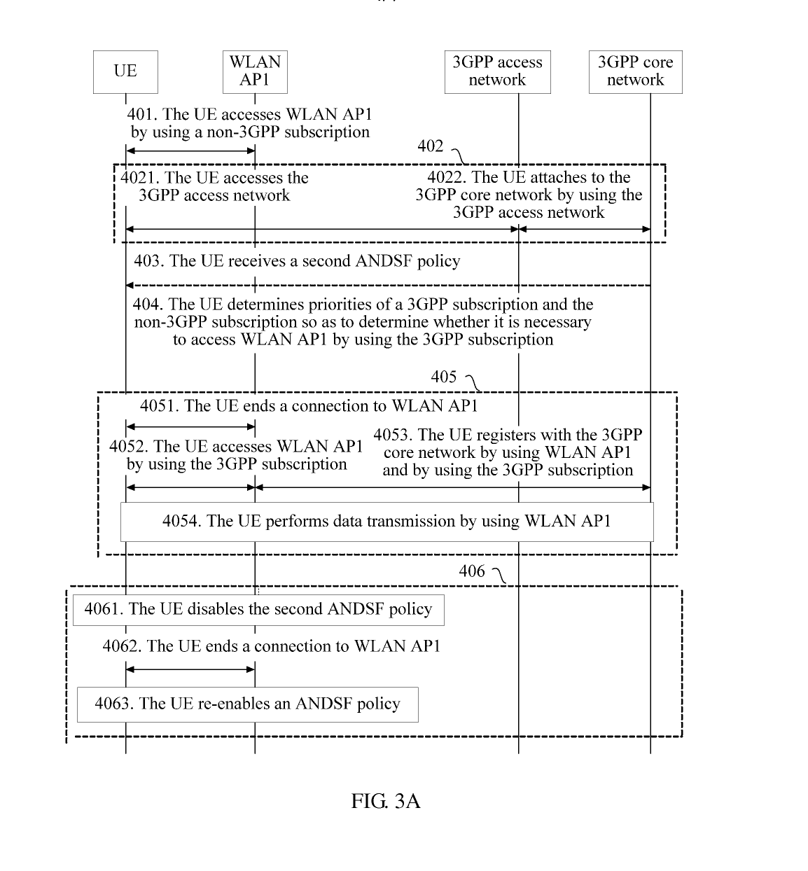

FIG. 4 is a schematic architectural diagram of Embodiment 1 of user equipment according to the present invention. As shown in FIG. 4, the user equipment in this embodiment may include: a first connection module 11, configured to access a first wireless local area network WLAN access device by using a non-3rd Generation Mobile Communication 3GPP subscription; a second connection module 12, configured to attach to a 3GPP core network by using a 3GPP access network; a determining module 13, configured to determine whether a 3GPP subscription has a higher priority than the non-3GPP subscription; and a third connection module 14, configured to: if the 3GPP subscription has a higher priority than the non-3GPP subscription, access a WLAN by using the 3GPP subscription.

The user equipment in this embodiment may be configured to perform the technical solution of the method embodiment shown in FIG. 1. The user equipment accesses the first WLAN network access device by using the first connection module and by using the non-3GPP subscription, and attaches to the 3GPP core network by using the second connection module and by using the 3GPP access network; when the determining module determines that the 3GPP subscription has a higher priority than the non-3GPP subscription in accessing a WLAN network access device, the user equipment accesses the WLAN network access device by using the third connection module and by using the 3GPP subscription. In this case, the following problems are avoided: a WLAN network access device reselected by the user equipment according to an ANDSF policy may conflict with a WLAN access device currently accessed by the user equipment by using the non-3GPP subscription, and a manner, which is of accessing a WLAN network by the user equipment and uses the 3GPP subscription instead of the non-3GPP subscription, may conflict with a manner in which the user equipment is expected to access the WLAN by using the non-3GPP subscription. In addition, an acquiring module of the user equipment autonomously acquires network access requirement information of a user in this embodiment, and the ANDSF policy does not need to be frequently checked in a periodic manner or in an event-triggered mode, thereby avoiding an increase in power consumption of the user equipment caused by unnecessary reselection of a WLAN access device.

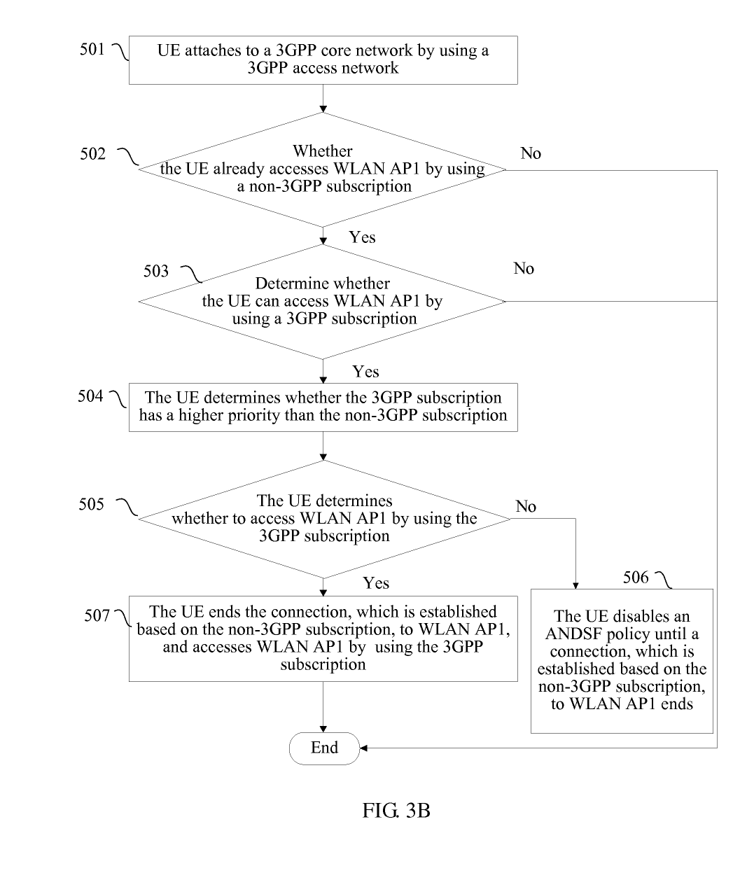

FIG. 5 is a schematic architectural diagram of Embodiment 2 of user equipment according to the present invention. As shown in FIG. 5, based on the user equipment shown in FIG. 4, the user equipment in this embodiment further includes: a first receiving module 15, configured to receive a first access network discovery and selection function ANDSF policy sent by the 3GPP core network; and a selecting module 16, configured to select a second WLAN access device according to the first ANDSF policy; and the third connection module 14 is configured to: if the determining module 13 determines that the 3GPP subscription has a higher priority than the non-3GPP subscription, end a connection to the first WLAN access device, and access the second WLAN access device by using the 3GPP subscription.

Further, the user equipment may further include: a first disabling module 17, configured to: if the 3GPP subscription does not have a higher priority than the non-3GPP subscription, disable or ignore the first ANDSF policy; and a first re-enabling module 18, configured to: if the first ANDSF policy is disabled or ignored, re-enable the first ANDSF policy after the connection to the first WLAN access device ends.

Further, the first connection module 11 is further configured to first access the first WLAN access device by using the non-3GPP subscription; the second connection module 12 is configured to: after the first connection module 11 first accesses the first WLAN access device by using the non-3GPP subscription, then attach the 3GPP core network by using the 3GPP access network; the determining module 13 is further configured to determine whether the first WLAN access device can be accessed by using the 3GPP subscription; and the third connection module 14 is configured to: if the determining module 13 determines that the first WLAN access device can be accessed by using the 3GPP subscription, access the first WLAN access device by using the 3GPP subscription.

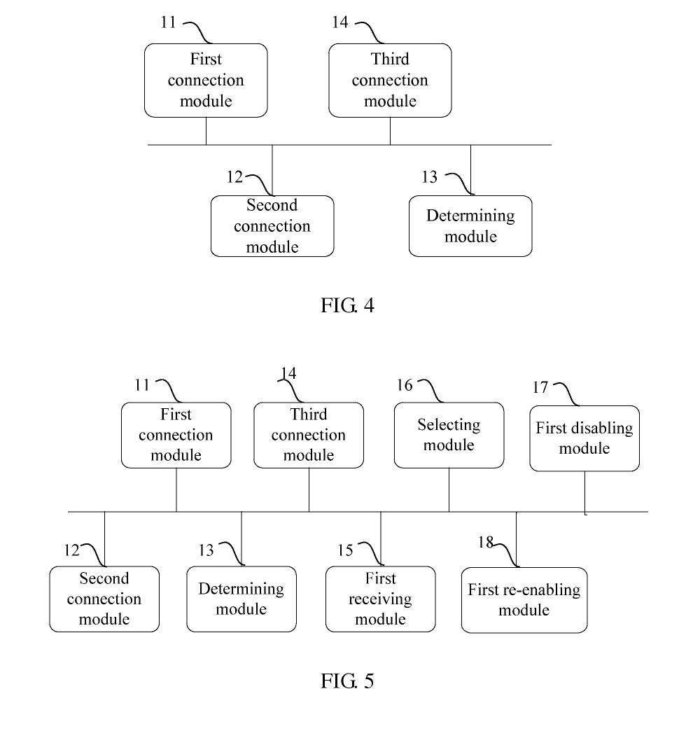

FIG. 6 is a schematic architectural diagram of Embodiment 3 of user equipment according to the present invention. As shown in FIG. 6, based on the user equipment shown in FIG. 5, the user equipment in this embodiment may further include: a second receiving module 19, configured to receive a second access network discovery and selection function ANDSF policy sent by the 3GPP core network; a second disabling module 20, configured to: if the 3GPP subscription does not have a higher priority than the non-3GPP subscription, disable or ignore the second ANDSF policy; and a second re-enabling module 21, configured to: if the second ANDSF policy is disabled or ignored, enable the second ANDSF policy after a connection to the first WLAN access device ends.

Further, the determining module 13 is specifically configured to: acquire user preference information about whether to access a WLAN by preferentially using a 3GPP subscription; or acquire a subscription priority that is in a management object and about whether to access a WLAN by preferentially using a 3GPP subscription; or send, to a user, prompt information about whether to access a WLAN by preferentially using a 3GPP subscription, and receive selection information that is input according to the prompt information by the user.

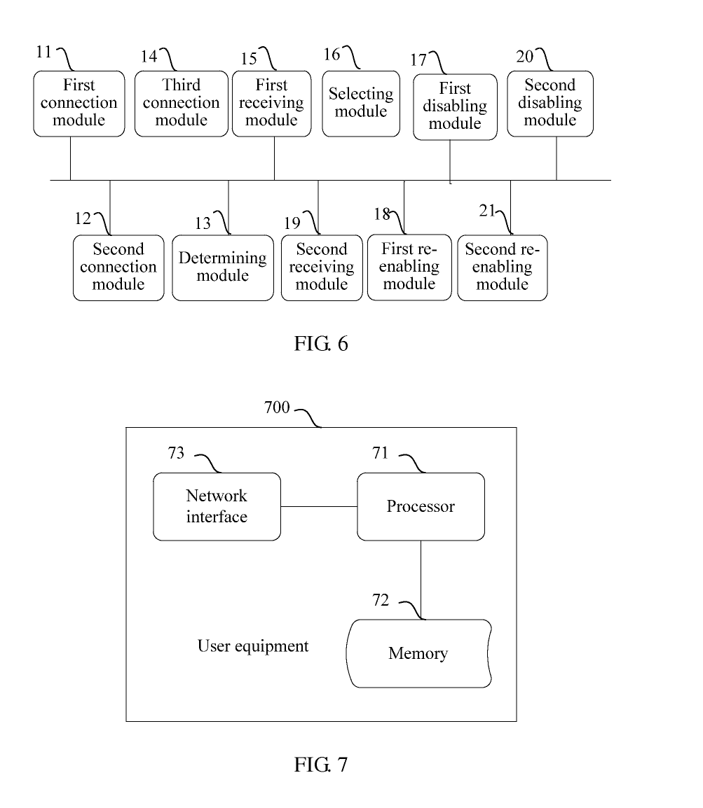

FIG. 7 is a schematic architectural diagram of Embodiment 4 of user equipment according to the present invention. As shown in FIG. 7, user equipment 700 in this embodiment may include: a processor 71, a memory 72, and a network interface 73, where the memory 72 stores an execution instruction; when the user equipment 700 is working, the processor 71 communicates with the memory 72; the processor 71 is connected to the network interface 73; the network interface 73 includes a network interface that communicates with another network, such as a WLAN network or a 3GPP network; the processor 71 executes the execution instruction to enable the user equipment 700 to execute the following operations: accessing, by the user equipment 700, a first wireless local area network WLAN access device by using a non-3rd Generation Mobile Communication 3GPP subscription, and attaching to a 3GPP core network by using a 3GPP access network; determining whether a 3GPP subscription has a higher priority than the non-3GPP subscription; and accessing, if the 3GPP subscription has a higher priority than the non-3GPP subscription, a WLAN by using the 3GPP subscription.

Optionally, before the determining whether a 3GPP subscription has a higher priority than the non-3GPP subscription, the following operation is included: receiving, by the user equipment 700 through the network interface 73, a first access network discovery and selection function ANDSF policy sent by the 3GPP core network, and selecting a second WLAN access device according to the first ANDSF policy.

Optionally, the accessing, if the 3GPP subscription has a higher priority than the non-3GPP subscription, a WLAN by using the 3GPP subscription includes: if the 3GPP subscription has a higher priority than the non-3GPP subscription, ending a connection to the first WLAN access device, and accessing the second WLAN access device by using the 3GPP subscription.

Optionally, if the 3GPP subscription does not have a higher priority than the non-3GPP subscription, the first ANDSF policy is disabled or ignored.

Optionally, after the first ANDSF policy is disabled or ignored, the following operation is further included: re-enabling the first ANDSF policy after the connection to the first WLAN access device ends.

Optionally, the accessing a first WLAN access device by using a non-3GPP subscription, and attaching to a 3GPP core network by using a 3GPP access network includes: accessing the first WLAN access device by using the non-3GPP subscription, and then attaching to the 3GPP core network by using the 3GPP access network; and the accessing, if the 3GPP subscription has a higher priority than the non-3GPP subscription, a WLAN by using the 3GPP subscription includes: determining whether the first WLAN access device can be accessed by using the 3GPP subscription, and if yes, accessing the first WLAN access device by using the 3GPP subscription.

Optionally, a second ANDSF policy sent by the 3GPP core network is received, and if the 3GPP subscription does not have a higher priority than the non-3GPP subscription, the second ANDSF policy is disabled or ignored.

Optionally, after the second ANDSF policy is disabled or ignored, the following operation is further included: enabling the second ANDSF policy after a connection to the first WLAN access device ends.

Optionally, the determining whether a 3GPP subscription has a higher priority than the non-3GPP subscription includes: acquiring user preference information about whether to access a WLAN by preferentially using a 3GPP subscription; or acquiring a subscription priority that is in a management object and about whether to access a WLAN by preferentially using a 3GPP subscription; or sending, to a user, prompt information about whether to access a WLAN by preferentially using a 3GPP subscription, and receiving selection information that is input according to the prompt information by the user.

Finally, it should be noted that the foregoing embodiments are merely intended for describing the technical solutions of the present invention, but not for limiting the present invention. Although the present invention is described in detail with reference to the foregoing embodiments, a person of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A network selection method, comprising:
accessing a first wireless local area network (WLAN) access device using a non-3rd Generation Mobile Communication (3GPP) subscription;
attaching to a 3GPP core network using a 3GPP access network;
determining whether a 3GPP subscription has a higher priority than the non-3GPP subscription; and
accessing a WLAN using the 3GPP subscription in response to determining that the 3GPP subscription has a higher priority than the non-3GPP subscription.

2. The method according to claim 1, wherein the method further comprises receiving a first access network discovery and selection function (ANDSF) policy sent by the 3GPP core network, and selecting a second WLAN access device according to the first ANDSF policy; and
wherein accessing the WLAN by using the 3GPP subscription comprises ending a connection to the first WLAN access device and accessing the second WLAN access device using the 3GPP subscription.

3. The method according to claim 2, further comprising disabling or ignoring the first ANDSF policy in response to determining that the 3GPP subscription does not have a higher priority than the non-3GPP subscription.

4. The method according to claim 3, further comprising re-enabling the first ANDSF policy after the connection to the first WLAN access device ends.

5. The method according to claim 1, wherein:
accessing the first WLAN access device using the non-3GPP subscription and attaching to the 3GPP core network using the 3GPP access network comprises accessing the first WLAN access device using the non-3GPP subscription, and then attaching to the 3GPP core network by using the 3GPP access network; and
accessing the WLAN using the 3GPP subscription in response to determining that the 3GPP subscription has a higher priority than the non-3GPP subscription comprises determining whether the first WLAN access device can be accessed using the 3GPP subscription, and accessing the first WLAN access device using the 3GPP subscription in response to determining that the first WLAN access device can be accessed using the 3GPP subscription.

6. The method according to claim 5, further comprising:
receiving a second ANDSF policy sent by the 3GPP core network; and
disabling or ignoring the second ANDSF policy in response to determining that the 3GPP subscription does not have a higher priority than the non-3GPP subscription.

7. The method according to claim 6, further comprising enabling the second ANDSF policy after a connection to the first WLAN access device ends.

8. The method according to claim 1, wherein determining whether a 3GPP subscription has a higher priority than the non-3GPP subscription comprises acquiring user preference information about whether to access a WLAN by preferentially using a 3GPP subscription.

9. The method according to claim 1, wherein determining whether a 3GPP subscription has a higher priority than the non-3GPP subscription comprises acquiring a subscription priority that is in a management object and about whether to access a WLAN by preferentially using a 3GPP subscription.

10. The method according to claim 1, wherein determining whether a 3GPP subscription has a higher priority than the non-3GPP subscription comprises sending, to a user, prompt information about whether to access a WLAN by preferentially using a 3GPP subscription, and receiving selection information that is input according to the prompt information by the user.

11. A network selection method, comprising:
accessing a first wireless local area network (WLAN) access device using a non-3rd Generation Mobile Communication (3GPP) subscription;
attaching to a 3GPP core network using a 3GPP access network;
determining that a 3GPP subscription has a higher priority than the non-3GPP subscription; and
accessing a WLAN using the 3GPP subscription in response to determining that the 3GPP subscription has a higher priority than the non-3GPP subscription.

12. User equipment, comprising a processor, a memory and a network interface, wherein the network interface is configured to communicate with another network, the memory stores execution instruction, and the processor executes the execution instructions to enable the user equipment to execute the following operations:
accessing, a first wireless local area network (WLAN) access device using a non-3rd Generation Mobile Communication (3GPP) subscription, and attaching to a 3GPP core network using a 3GPP access network;
determining whether a 3GPP subscription has a higher priority than the non-3GPP subscription; and
accessing a WLAN by using the 3GPP subscription in response to determining that the 3GPP subscription has a higher priority than the non-3GPP subscription.

13. The user equipment according to claim 12, wherein the execution instructions further include instructions for receiving a first access network discovery and selection function (ANDSF) policy sent by the 3GPP core network, and selecting a second WLAN access device according to the first ANDSF policy before determining whether the 3GPP subscription has a higher priority than the non-3GPP subscription.

14. The user equipment according to claim 13, wherein accessing the WLAN using the 3GPP subscription in response to determining that the 3GPP subscription has a higher priority than the non-3GPP subscription includes ending a connection to the first WLAN access device in response to determining that the 3GPP subscription has a higher priority than the non-3GPP subscription, and accessing the second WLAN access device by using the 3GPP subscription.

15. The user equipment according to claim 14, wherein the execution instructions further include instructions for disabling or ignoring the first ANDSF policy in response to determining that the 3GPP subscription does not have a higher priority than the non-3GPP subscription.

16. The user equipment according to claim 15, wherein the execution instructions further include instructions for, after the disabling or ignoring the first ANDSF policy, re-enabling the first ANDSF policy after the connection to the first WLAN access device ends.

17. The user equipment according to claim 12, wherein:
accessing the first WLAN access device using the non-3GPP subscription, and attaching to the 3GPP core network using the 3GPP access network, comprises accessing the first WLAN access device using the non-3GPP subscription, and then attaching to the 3GPP core network by using the 3GPP access network; and
accessing a WLAN by using the 3GPP subscription in response to determining that the 3GPP subscription has a higher priority than the non-3GPP subscription comprises determining whether the first WLAN access device can be accessed by using the 3GPP subscription, and accessing the first WLAN access device using the 3GPP subscription in response to determining that the first WLAN access device can be accessed using the 3GPP subscription.

18. The user equipment according to claim 17, wherein the execution instructions further include instructions for receiving a second ANDSF policy sent by the 3GPP core network, and disabling or ignoring the second ANDSF policy, in response to determining that the 3GPP subscription does not have a higher priority than the non-3GPP subscription.

19. The user equipment according to claim 17, wherein the execution instructions further include instructions for after the disabling or ignoring the second ANDSF policy and enabling the second ANDSF policy after a connection to the first WLAN access device ends.

20. The user equipment according to claim 12, wherein determining whether the 3GPP subscription has a higher priority than the non-3GPP subscription comprises:
acquiring user preference information about whether to access a WLAN by preferentially using a 3GPP subscription; or
acquiring a subscription priority that is in a management object and about whether to access a WLAN by preferentially using a 3GPP subscription; or
sending, to a user, prompt information about whether to access a WLAN by preferentially using a 3GPP subscription, and receiving selection information that is input according to the prompt information by the user.
